(19) United States
(12) Patent Application Publication
(10) Pub. No.: US 2005/0242962 A1
(43) Pub. Date: Nov. 3, 2005

(54) Tag device, luggage tag, and method of manufacturing a tag device

(76) Inventors: Michael A. Lind, Kent, WA (US); Mario J. Bagaglio, Richland, WA (US); Gary B. Morgan, Kennewick, WA (US)

Correspondence Address: WELLS ST. JOHN P.S., 601 W. FIRST AVENUE, SUITE 1300, SPOKANE, WA, 99201, US

(21) Appl. No.: 10/837,128

(22) Filed: Apr. 29, 2004

(51) Int. Cl. G08B 13/14

(52) U.S. Cl. 340/572.8; 340/568.2

(57) ABSTRACT

A tag device includes a strap having a first end and a second end and configured to encircle a member to which the tag device is to be secured, the first end being configured to be attached to the second end of the strap, with the strap encircling a member to which the tag device is to be secured; and circuitry supported by the strap and useful for determining if the strap has been removed from the member after the first end has been attached to the second end. Other apparatus and a method of manufacturing a tag device are also provided.

### GOVERNMENT RIGHTS

This invention was made with government support under contract number DE-AC0676RLO1830 awarded by the U.S. Department of Energy. The Government has certain rights in the invention.

### TECHNICAL FIELD

The invention relates to tags and labels. Some aspects of the invention relate to luggage tags of the type used by airlines for routing luggage from one airport to another. Other aspects of the invention relate to tags, labels, or wristbands of the type used to control access to events or locations.

### BACKGROUND OF THE INVENTION

Tags, labels, and wristbands of the type used for identification or to control access to events or locations are known in the art. Wristbands are disclosed, for example, in the following U.S. patents which are incorporated herein by reference: U.S. Pat. No. 5,914,197 to Goudjil, U.S. Pat. No. 1,151,940 to Gauvrea, U.S. Pat. No. 1,407,239 to Weiss, and U.S. Pat. No. 1,427,891 to Ziegler. Such devices can be used, for example, in areas of large crowds so as to identify people whose age has been verified to allow access to a restricted area (e.g., where alcohol is served). Such devices can also be used for security, to identify members of a group, to identify people entitled to special privileges, to identify people who have paid for admission to an event, tour, or area, to identify people who meet height restrictions or in any application where a quick visual means of identification is needed. A problem with such devices is that there is a risk that someone may surreptitiously remove the wristband or other device and attempt to transfer it to someone who is not entitled to use it (e.g., someone who is underage or otherwise not entitled to access to a restricted area). Attempts have been made to construct wristbands out of Mylar™ and to place perforations in overlapping ends that are secured together with adhesive so as to make it more difficult to remove such wristbands. However, it may be possible to cut them with scissors and use tape to transfer them to someone else and make them appear to be intact.

Remote communication utilizing wireless equipment typically relies on radio frequency (RF) technology, which is employed in many industries. One application of RF technology is in locating, identifying, and tracking objects, such as animals, inventory, and vehicles.

RF identification (RFID) tag systems have been developed to identify, monitor, or control remote objects.

An advantage of RFID systems is the non-contact, non-line-of-sight capability of the technology. Tags can be read through a variety of substances such as snow, fog, ice, paint, dirt; and other visually and environmentally challenging conditions where bar codes or other optically-read technologies would be useless. RF tags can also be read at remarkable speeds, in most cases responding in less than one hundred milliseconds.

There are three main categories of RFID tag systems. These are systems that employ beam-powered passive tags, battery-powered semi-passive tags, and active tags. Each operates in fundamentally different ways. The invention described below in the Detailed Description can be embodied in any of these types of systems.

The beam-powered RFID tag is often referred to as a passive device because it derives the energy needed for its operation from the radio frequency energy beamed at the tag. The tag rectifies the field and changes the reflective characteristics of the tag itself, creating a change in reflectivity (RF cross-section) that is seen at the interrogator. A battery-powered semi-passive RFID tag operates in a similar fashion, modulating its RF cross-section in order to change its reflectivity that is seen at the interrogator to develop a communication link. Here, the battery is the only source of the tag's operational power. Finally, in the active RFID tag, both the tag and reader have transceivers to communicate and are powered by respective batteries.

A typical RF tag system will contain at least one tag and one interrogator. The range of communication for such tags varies according to the transmission power of the interrogator, interrogator receiver sensitivity and selectivity, and backscatter characteristics of the tag. Battery-powered tags operating at 2,450 MHz have traditionally been limited to less than ten meters in range. However, devices with sufficient power can reach in excess of 100 meters in range, depending on the frequency and environmental characteristics.

Conventional continuous wave backscatter RF tag systems utilizing passive (no battery) RF tags require adequate power from a signal from the interrogator to power the internal circuitry in the tag used to modulate the signal back to the interrogator. While this is successful for tags that are located in close proximity to an interrogator, for example less than three meters, this may be insufficient range for some applications, for example greater than 100 meters.

### SUMMARY OF THE INVENTION

Some embodiments of the invention provide a tag device comprising a strap having a first end and a second end and configured to encircle a member to which the tag device is to be secured, the first end being configured to be attached to the second end of the strap, with the strap encircling a member to which the tag device is to be secured; and circuitry supported by the strap and useful for determining if the strap has been removed from the member after the first end has been attached to the second end.

Other embodiments of the invention provide a luggage tag comprising a strap having first and second opposite surfaces, the first surface having adhesive thereon, the second surface having an area configured to be printed with indicia, the strap being configured, in use, to have first and second opposite ends and to encircle a member to which the tag device is to be secured with a portion of the first surface, proximate the first end, overlaying and affixed by the adhesive to another portion of the first surface, proximate second end of the strap, with the strap encircling a member to which the tag is to be secured; and circuitry supported by the strap and configured to be used to determine if the strap has been removed from the member after the first end has been attached to the second end, the strap being configured such that the strap breaks at a location other than the first and second ends if the strap is removed from the member, the circuitry being configured to break if the strap breaks.

Still other embodiments of the invention provide a luggage tag comprising a strap having first and second opposite surfaces, the first surface having adhesive thereon, the second surface having indicia thereon, the strap being configured, in use, to have first and second opposite ends and to encircle a member to which the tag device is to be secured with a portion of the first surface, proximate the first end, overlaying and affixed by the adhesive to another portion of the first surface, proximate second end of the strap, with the strap encircling a member to which the tag is to be secured; and circuitry supported by the strap and configured to be used to determine if the strap has been removed from the member after the first end has been attached to the second end, the strap being configured such that the strap breaks at a location other than the first and second ends if the strap is removed from the member, the circuitry being configured to break if the strap breaks, the circuitry including an RFID integrated circuit and a conductor coupled to the integrated circuit and extending along the strap.

Other embodiments provide a method of manufacturing a tag device comprising providing a strap having a first end and a second end and configured to encircle a member to which the tag device is to be secured; configuring the first end to be attached to the second end of the strap, with the strap encircling a member to which the tag device is to be secured; and supporting circuitry from the strap, the circuitry being useful for determining if the strap has been removed from the member after the first end has been attached to the second end.

In some embodiments, manifest data is securely encoded into the tag device so that it is not possible for unauthorized personnel to read or change the data either at initial entry or during the valid period of the tag. This is performed, in various embodiments, by using any of various forms of encryption, time sensitive codes, revolving entry codes, or unauthorized entry disruption/disabling features.

### BRIEF DESCRIPTION OF THE DRAWINGS

Preferred embodiments of the invention are described below with reference to the following accompanying drawings.

FIG. 1 is a top view of a tag in accordance with various embodiments of the invention.

FIG. 2 is a bottom view of the tag of FIG. 1, in accordance with various embodiments.

FIG. 3 is a circuit schematic of circuitry included with various embodiments of the tag of FIGS. 1 and 2.

FIG. 4 is a perspective view of a suitcase with a tag device in accordance with various embodiments.

FIG. 5 is a perspective view of a person's arm with a tag device in accordance with various embodiments.

### DETAILED DESCRIPTION OF THE PREFERRED EMBODIMENTS

Attention is directed to the following commonly assigned applications, which are incorporated herein by reference:

U.S. patent application Ser. No. 10/263,826, filed Oct. 2, 2002, entitled “Radio Frequency Identification Device Communications Systems, Wireless Communication Devices, Backscatter Communication Methods and Radio Frequency Identification Device Communication Methods,” by inventors Mike A. Hughes and Richard M. Pratt; U.S. patent application Ser. No. 10/263,809, filed Oct. 2, 2002, entitled “Method of Simultaneously Reading Multiple Radio Frequency Tags, RF Tag, and RF Reader,” by inventors Emre Ertin, Richard M. Pratt, Mike A. Hughes, Kevin L. Priddy, and Wayne M. Lechelt; U.S. patent application Ser. No. 10/263,873, filed Oct. 2, 2002, entitled “RFID System and Method Including Tag ID Compression,” by inventors Richard M. Pratt and Mike A. Hughes; U.S. patent application Ser. No. 10/264,078, filed Oct. 2, 2002, entitled “System and Method to Identify Multiple RF Tags,” by inventors Mike A. Hughes and Richard M. Pratt; U.S. patent application Ser. No. 10/263,997, filed Oct. 2, 2002, entitled “Wireless Communication Systems, Radio Frequency Identification Devices, Methods of Enhancing a Communications Range of a Radio Identification Frequency Device, and Wireless Communication Methods,” by inventors Richard Pratt and Steven B. Thompson; U.S. patent application Ser. No. 10/263,670 filed Oct. 2, 2002, entitled “Wireless Communications Devices, Methods of Processing a Wireless Communication Signal, Wireless Communication Synchronization Methods and a Radio Frequency Identification Device Communication Method,” by inventors Richard M. Pratt and Steven B. Thompson; U.S. patent application Ser. No. 10/263,656, filed Oct. 2, 2002, entitled “Wireless Communications Systems, Radio Frequency Identification Devices, Wireless Communications Methods, and Radio Frequency Identification Device Communications Methods,” by inventors Richard Pratt and Steven B. Thompson; U.S. patent application Ser. No. 10/263,635, filed Oct. 2, 2002, entitled “A Challenged-Based Tag Authentication Model,” by inventors Mike A. Hughes and Richard M. Pratt; U.S. patent application Ser. No. 09/589,001, filed Jun. 6, 2000, entitled “Remote Communication System and Method,” by inventors R. W. Gilbert, G. A. Anderson, K. D. Steele, and C. L. Carrender; U.S. patent application Ser. No. 09/802,408; filed Mar. 9, 2001, entitled “Multi-Level RF Identification System,” by inventors R. W. Gilbert, G. A. Anderson, and K. D. Steele; U.S. patent application Ser. No. 09/833,465, filed Apr. 11, 2001, entitled “System and Method for Controlling Remote Device,” by inventors C. L. Carrender, R. W. Gilbert, J. W. Scott, and D. Clark; U.S. patent application Ser. No. 09/588,997, filed Jun. 6, 2000, entitled “Phase Modulation in RF Tag,” by inventors R. W. Gilbert and C. L. Carrender; U.S. patent application Ser. No. 09/589,000, filed Jun. 6, 2000, entitled “Multi-Frequency Communication System and Method,” by inventors R. W. Gilbert and C. L. Carrender; U.S. patent application Ser. No. 09/588,998; filed Jun. 6, 2000, entitled “Distance/Ranging by Determination of RF Phase Delta,” by inventor C. L. Carrender; U.S. patent application Ser. No. 09/797,539, filed Feb. 28, 2001, entitled “Antenna Matching Circuit,” by inventor C. L. Carrender; U.S. patent application Ser. No. 09/833,391, filed Apr. 11, 2001, entitled “Frequency Hopping RFID Reader,” by inventor C. L. Carrender.

Further, an electronic security device is disclosed in commonly assigned U.S. Pat. No. 5,097,253 to Eschbach et al., incorporated herein by reference.

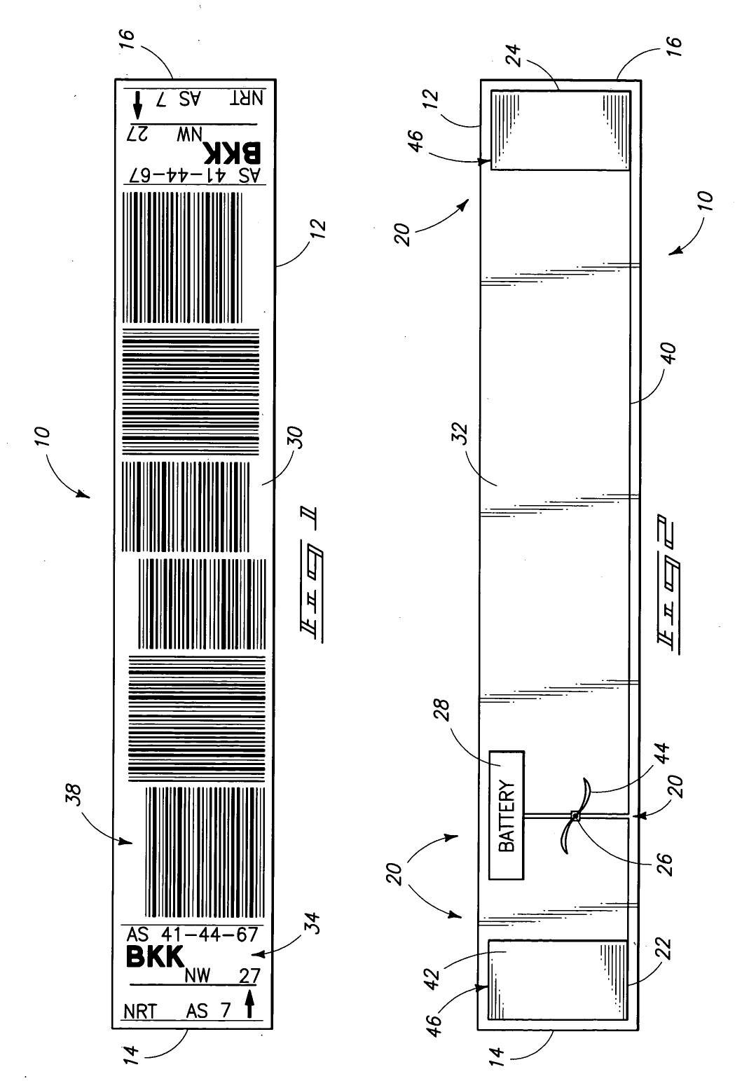

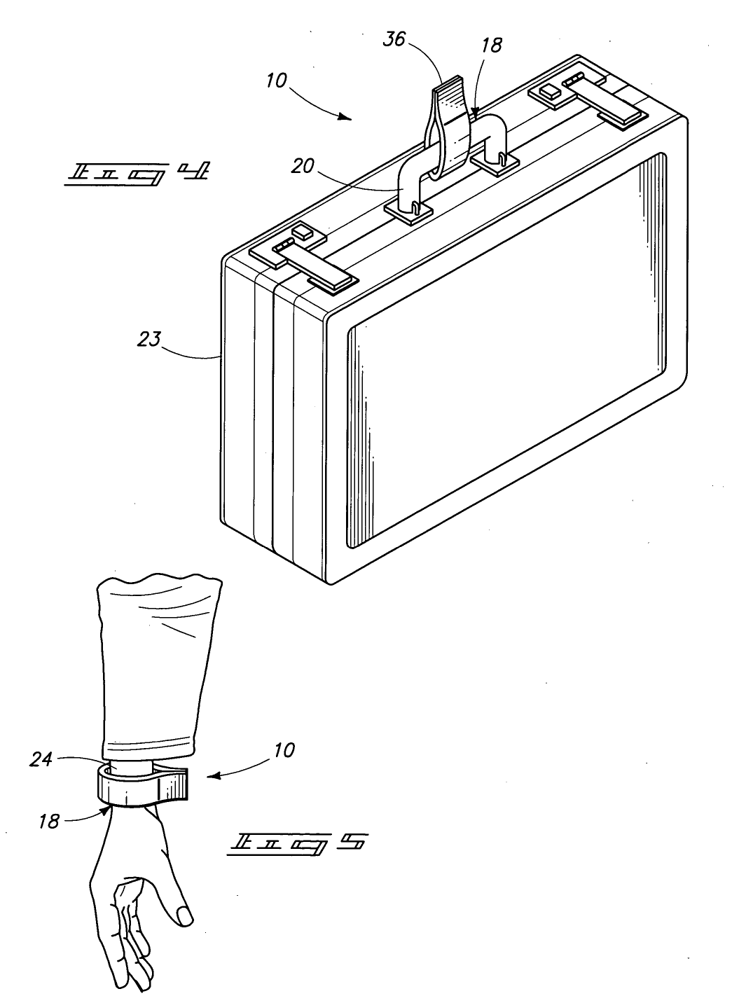

FIG. 1 shows a tag device 10 in accordance with various aspects of the invention. The tag device 10 includes a strap 12 having a first end 14 and a second end 16. The strap 12 is sized to encircle a member 18 to which the tag device 10 is to be secured, such as a handle 20 of a bag 23 (e.g., a suitcase, briefcase or other luggage item) (FIG. 4) or a wrist 24 (FIG. 5). The first end 14 (or an area proximate the first end 14) is configured to be attached to the second end 16 (or an area proximate the second end 16) of the strap 12, with the strap 12 encircling the member 18 to which the tag device 10 is to be secured. More particularly, in the illustrated embodiment, the second surface 32 has adhesive 42 thereon proximate the first end 14 and the first end is configured to be attached to the second end using this adhesive. In some embodiments, the adhesive is covered with a removable protective layer (e.g., wax paper) until ready for use. In some embodiments, the second surface 32 has adhesive thereon proximate the second end 16 as well as proximate the first end 14. In some embodiments, this adhesive is covered with a removable protective layer (e.g., wax paper) until ready for use.

The tag device 10 includes circuitry 20 supported by the strap. The circuitry 20, in operation, is used to determine if the strap 12 has been removed from the member 18 after the first end 14 has been attached to the second end 16.

The circuitry 20 includes a first conductor (or loop end or conductor pattern) 22 supported by the first end 14 and a second conductor (or loop end or conductor pattern) 24 supported by the second end 16. The first conductor 22 is configured to be electrically coupled to second conductor 24 when the first end 14 is attached to the second end 16. In the illustrated embodiment, the circuitry 20 is configured to open-circuit or to present an impedance change if the strap 12 is removed from the member 18.

Any secure loop configuration can be employed. In some embodiments, direct contact loop conductivity interruption is used to detect removal of the strap 12 from the member 18. In alternative embodiments, E-M coupling of conductors 22 and 24 via an overlapping AC current loop is used. For example, a secure loop can be a contact design or non-contact design. The loop can be direct contact and monitor the lack of a DC current, for example. Alternatively, the loop can monitor an AC impedance discontinuity whether via a magnetic field or a capacitive disruption.

In some embodiments, an encrypted coding method is employed to provide loop security. In some embodiments, data is securely stored in the tag device 10. There are many alternative existing public/private key code techniques that could be employed or a new one could be devised. In this case, because data is being exchanged with known entities under direct control, a private encryption key can be used and can be as lengthy as there is memory to support.

Phase and/or amplitude modulation encoding can be employed to encode the loop so that it cannot be easily tampered with. For example, tampering by adding a longer length to the connection will be detected.

In the communication protocol for the integrated circuit 26, the response (and the instructions from the interrogator to the integrated circuit 26 for that matter) can be encrypted in some embodiments, using a secure code key, so that it is not recognizable to anyone but an authorized interrogator. The code can be fixed, public/private, or changing like the Secure ID token.

The strap 12 has a length in the direction from the first end 14 to the second end 16. In the illustrated embodiment, the circuitry 20 includes a conductor 40 substantially extending along the length of the strap, from the first end 14 to the second end 16, and the conductor 40 is configured to break if the strap 12 is broken.

The circuitry includes, in an alternative embodiment (not shown), fiber optic cables instead of conductors 22 and 24. The fiber optic cables are configured to be coupled to each other when the first end 14 is attached to the second end 16.

The circuitry 20 includes an integrated circuit 26. In the illustrated embodiment, the integrated circuit 26 is an RFID integrated circuit which can be interrogated when the first conductor 22 is electrically coupled to the second conductor 24 if the strap 12 has not been broken. Various RFID integrated circuit configurations that could be used are included in the above-listed incorporated applications and patents. In the illustrated embodiment, the RFID integrated circuit 26 is a backscatter tag including memory to store data written into or permanently encoded into the tag and other circuitry for the RFID IC 26 to take information into the RFID IC 26 and relay information out of the RFID IC 26.

In some embodiments, such as embodiments in which the circuitry does not use a magnetic link for power, or if extended range is desired, the tag device 10 further comprises a battery 28 supported by the strap 12 and coupled to the integrated circuit 26. In the illustrated embodiment, the battery 28 is a thin film battery.

The circuitry 20 further includes an antenna 44. The antenna can be any one of a variety of designs and, in the illustrated embodiment, is tuned to maximize the sensitivity and the range of the RFID IC 26 over the frequency range of the RFID IC 26 in the operational environment of the RFID IC 26.

A more detailed block diagram of circuitry 20, in accordance with some embodiments is shown in FIG. 3. The circuitry 20 shown in FIG. 3 includes the antenna 44. The antenna 44, in some embodiments, is tuned for the operational frequency, the substrate, and the operating environment of the circuitry 20. There may be one antenna for receiving and a second for reflecting, or a single structure may be provided for both receiving and reflecting or transmitting.

The circuitry 20 shown in FIG. 3 includes the battery 28. In some embodiments, the battery is sized to provide sufficient power to operate the circuitry 20 over its expected service life. The battery 28 may be, for example, any of a number of thin film batteries such as those available from PowerPaper Ltd., 21 Yegia Kapayim Street, Kiryat Arye, Petah Tikua, P.O.B. 3353, Israel 49130, Solicore Inc., 2700 Interstate Drive, Lakeland, Fla. 33805, or a number of other providers.

The circuitry 20 shown in FIG. 3 further includes a loop 46 that has two ends and provides a closed circuit when the two ends are in contact or close proximity. The loop 46 is defined by the conductors 22 and 24. The loop 46 may be either direct contact or proximity based (capacitive or inductive) and may be either DC or AC. In some embodiments, an AC inductive design is employed because such a design lessens the requirements of precision alignment of the loop ends.

The circuitry 20 shown in FIG. 3 further includes a logic processor 50. The logic processor 50 acts as a digital state machine, in some embodiments. The logic processor 50 monitors functions such as modulator codes, battery level if so designed, loop status, user interfaces, etc. and responds to instruction sets programmed in memory 52, described below.

The circuitry 20 shown in FIG. 3 further includes an RF detector/modulator 48 coupled to the antenna 44. The RF modulator/demodulator detects an RF signal incoming from an interrogator transmitter 58 and presents a demodulated data signal to a logic processor 50. The RF detector/modulator 48 also accepts a signal from the processor 50 and modulates the impedance of the antenna which in turn modulates the incoming continuous wave signal from the interrogator 58 to provide a return signal to the interrogator 58 when the integrated circuit 26 communicates with the interrogator 58. The RF detector/modulator 48 may also contain a mixer and antenna switch for more complex antenna and modulation schemes.

The circuitry 20 shown in FIG. 3 further includes a memory 52 which contains an identification code of the integrated circuit 26 and instruction sets for the processor 50. In some embodiments, the memory 52 is non-volatile static memory that can be programmed via the processor 50, via a user interface 56, described below, or via an RF link with the interrogator 58 via the processor 50 depending on the specific design. The memory 52 may be any of various sizes depending on application requirements.

The circuitry 20 shown in FIG. 3 further includes loop driver and sense circuitry 54 that powers the loop 46 and monitors impedance of the loop. Depending on the level of sophistication of the integrated circuit 26, the circuitry 54 may contain a simple threshold detector, or a more subtle change detector. It may be based on a DC current or an inductive/reactive AC impedance.

The circuitry 20 shown in FIG. 3 further includes, in some embodiments, user interface 56. The user interface 56 allows direct electrical contact programming of the memory 52 and may also provide test functions for the integrated circuit 26.

In the illustrated embodiment, the RF detector modulator 48, logic processor 50, memory 52, loop driver/sense circuit 54, and user interface 56 are defined by the RFID integrated circuit 26. In some embodiments, for low cost production, all the blocks shown in FIG. 3 for the integrated circuit 26 are contained in a single mixed signal application specific integrated circuit (ASIC). Separate components can also be employed.

In some embodiments, the circuitry 20 is laminated onto the strap 12. In other embodiments, the circuitry includes conductors that are printed on the strap 12.

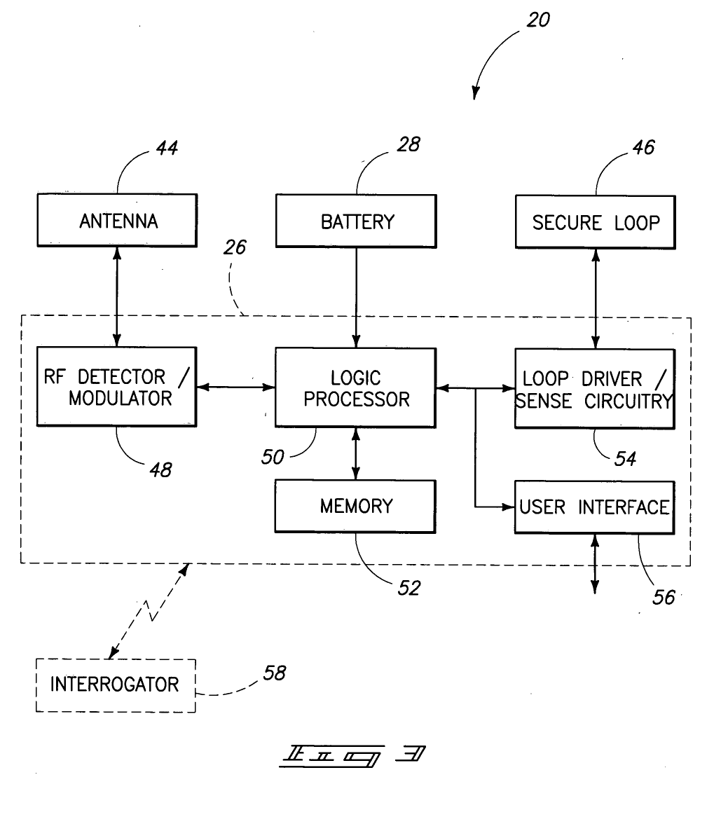

In the embodiment shown in FIGS. 1-2, the strap 12 has first and second opposite planar surfaces 30 and 32, and human readable indicia 34 printed on one of the surfaces 30 and 32. More particularly, in some embodiments (see FIG. 4), the strap 12 defines a luggage tag 36 and the human readable indicia comprises (see FIG. 1) airport routing information.

Machine readable indicia 38 (see FIG. 1) may be printed on one of the surfaces 30 and 32 instead of or in addition to the human readable indicia 34. In the illustrated embodiment, the machine readable indicia describes airport routing (e.g., the various flights on which the bag 23 should be sent and/or the various airports through which the bag 23 should be routed).

In embodiments in which the tag device defines a wristband, human readable and machine readable indicia could also be included or omitted. Human readable indicia could include color coding for differentiating whether or not someone is of legal drinking age, for example.

In some embodiments, a plurality of tag devices are formed together on a continuous roll. In these embodiments, the tag devices are separatable by a serrated blade or other device. This can be performed, for example, after having been printed on with airport routing information. In some of these embodiments, multiple of the tag devices on the roll have the same length, in view of the conductors. In these embodiments, the length will be sufficiently long to accommodate a plurality of airport connections printed on the strap.

In operation, the protective layer is removed, the strap 12 is wrapped around the member 18, and the ends 14 and 16 are overlapped and pressed together such that the ends adhere and the loop ends or conductors 22 and 24 overlap to create an operational loop circuit (either AC or DC).

The circuitry 20 is built to be a one time circuit that once broken (by cutting, tearing, or separating the two ends of the strap 12), is not repairable. This is accomplished, in some embodiments, through the use of friable materials and adhesives. For example, the structure of the adhesive 42 causes the circuitry 20, including loop ends 22 and 24, to fracture such that the circuit cannot be reestablished and does not allow proximity replacement for the circuit to be reestablished. This can be done, for example, by making the adhesive 42 proximate the ends 14 and 16 stronger than the material backing and the conductive material of the circuitry 20, thereby forcing a separation on the connecting conductor 40 which cannot be reattached, after the strap 12 is removed from a member 18.

The tag device design can be applied to other security devices or security tags where exchange of tags is undesirable and only one time use is necessary. Such applications include, for example, passenger wrist tickets, concert tickets, customs seals, container seals, book seals, safe seals, etc. The circuitry can be designed into plastic and paper carriers or placed into more rigid structures. The conductors can define loops in a number of configurations including two dimensional or three dimensional designs and, in some embodiments are monitored by the integrated circuit 26 using an AC or DC encoded loop monitoring signal. For example, with two loops, a source loop and a pick-up loop, they can be planar (2-D), next to one another, or layered one over the other (3-D). If a DC current is applied to the source loop, a DC potential will be induced in the pick-up loop if it is moved. If there is an AC current in the source loop, it will induce an AC potential in the pick-up loop.

In some embodiments, the sheets or methods of U.S. Pat. Nos. 5,543,191 and 5,418,026 to Dronzek, Jr. et al. are used in various embodiments.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A tag device comprising:
a strap having a first end and a second end and configured to encircle a member to which the tag device is to be secured, the first end being configured to be attached to the second end of the strap, with the strap encircling a member to which the tag device is to be secured; and
circuitry supported by the strap and useful for determining if the strap has been removed from the member after the first end has been attached to the second end.

2. A tag device in accordance with claim 1 wherein the circuitry includes a first conductor supported by the first end and a second conductor supported by the second end, and wherein the first conductor is configured to be electrically coupled to the second conductor when the first end is attached to the second end.

3. A tag device in accordance with claim 2 wherein the circuitry is configured to open-circuit if the strap is removed from the member.

4. A tag device in accordance with claim 2 wherein the circuitry includes an RFID integrated circuit which can be interrogated when the first conductor is electrically coupled to the second conductor if the strap has not been broken.

5. A tag device in accordance with claim 4 wherein the RFID integrated circuit includes memory configured to store encrypted data.

6. A tag device in accordance with claim 4 wherein the RFID integrated circuit is configured to store airport routing data in a secure manner.

7. A tag device in accordance with claim 4 and further comprising a battery supported by the strap and coupled to the RFID integrated circuit.

8. A tag device in accordance with claim 7 wherein the battery is a thin film battery.

9. A tag device in accordance with claim 1 wherein the circuitry is laminated onto the strap.

10. A tag device in accordance with claim 1 wherein the circuitry includes conductors that are printed on the strap.

11. A tag device in accordance with claim 1 wherein the strap has first and second opposite planar surfaces, and human readable indicia printed on one of the surfaces, the strap defining a luggage tag, the indicia describing airport routing.

12. A tag device in accordance with claim 1 wherein the strap has first and second opposite planar surfaces, and machine readable indicia printed on one of the surfaces, the strap defining a luggage tag, the indicia describing airport routing.

13. A tag device in accordance with claim 1 wherein the strap has a length in the direction from the first end to the second end and wherein the circuitry includes a conductor substantially extending from the first end to the second end, the conductor being configured to break if the strap is broken.

14. A tag-device in accordance with claim 1 wherein the first end has adhesive thereon and is configured to be attached to the second end using adhesive.

15. A tag device in accordance with claim 1 and defining a wristband.

16. A luggage tag comprising:
a strap having first and second opposite surfaces, the first surface having adhesive thereon, the second surface having an area configured to be printed with indicia, the strap being configured, in use, to have first and second opposite ends and to encircle a member to which the tag device is to be secured with a portion of the first surface, proximate the first end, overlaying and affixed by the adhesive to another portion of the first surface, proximate second end of the strap, with the strap encircling a member to which the tag is to be secured; and
circuitry supported by the strap and configured to be used to determine if the strap has been removed from the member after the first end has been attached to the second end, the strap being configured such that the strap breaks at a location other than the first and second ends if the strap is removed from the member, the circuitry being configured to break if the strap breaks.

17. A luggage tag in accordance with claim 16 wherein the second surface has indicia thereon, the indicia comprising human readable indicia including airport routing information.

18. A luggage tag in accordance with claim 16 wherein the second surface has indicia thereon, indicia comprising machine readable indicia including airport routing information.

19. A luggage tag in accordance with claim 16 wherein the circuitry includes an RFID integrated circuit which is selectively interrogated if the strap has not been broken.

20. A luggage tag in accordance with claim 19 and further comprising a battery supported by the strap and coupled to the RFID integrated circuit to supply power to the RFID integrated circuit.

21. A luggage tag in accordance with claim 20 wherein the battery is a thin film battery.

22. A luggage tag in accordance with claim 20 wherein the circuitry is laminated onto the strap.

23. A luggage tag in accordance with claim 20 wherein the circuitry includes conductors that are printed on the strap.

24. A luggage tag in accordance with claim 20 wherein the strap has a length in the direction from the first end to the second end and wherein the circuitry includes a conductor substantially extending from the first end to the second end, the conductor being configured to break if the strap is broken.

25. A luggage tag in accordance with claim 20 wherein the adhesive is sufficiently strong such that an attempt to remove the strap from the member results in the strap breaking at a location between the first end and the second end.

26. A luggage tag comprising:
a strap having first and second opposite surfaces, the first surface having adhesive thereon, the second surface having indicia thereon, the strap being configured, in use, to have first and second opposite ends and to encircle a member to which the tag device is to be secured with a portion of the first surface, proximate the first end, overlaying and affixed by the adhesive to another portion of the first surface, proximate second end of the strap, with the strap encircling a member to which the tag is to be secured; and
circuitry supported by the strap and configured to be used to determine if the strap has been removed from the member after the first end has been attached to the second end, the strap being configured such that the strap breaks at a location other than the first and second ends if the strap is removed from the member, the circuitry being configured to break if the strap breaks, the circuitry including an RFID integrated circuit and a conductor coupled to the integrated circuit and extending along the strap.

27. A luggage tag in accordance with claim 26 wherein the second surface has indicia thereon, the indicia comprising human readable indicia including information relating to cities through which a bag associated with the tag is intended to be routed and flights on which the bag is intended to travel.

28. A luggage tag in accordance with claim 26 wherein the second surface has indicia thereon, indicia comprising machine readable indicia including information relating to the cities through which a bag associated with the tag is intended to be routed and flights on which the bag is intended to travel.

29. A luggage tag in accordance with claim 26 wherein the RFID integrated circuit is capable of being interrogated if the strap has not been broken.

30. A luggage tag in accordance with claim 29 and further comprising a battery supported by the strap and coupled to the RFID integrated circuit.

31. A luggage tag in accordance with claim 30 wherein the battery is a thin film battery.

32. A luggage tag in accordance with claim 30 wherein the circuitry is laminated onto the strap.

33. A luggage tag in accordance with claim 30 wherein the conductor is printed on the strap.

34. A luggage tag in accordance with claim 30 wherein the strap has a length in the direction from the first end to the second end and wherein the conductor substantially extends from the first end to the second end, the conductor being configured to break if the strap is broken.

35. A luggage tag in accordance with claim 30 wherein the strap has a length in the direction from the first end to the second end, and wherein the conductor substantially extends from the integrated circuit to the first end, the luggage tag further including a second conductor extending from the integrated circuit to the second end, wherein the first mentioned conductor is electrically coupled to the second conductor when the first end is attached to the second end, and wherein the RFID integrated circuit is configured to detect whether the first mentioned conductor is electrically coupled to the second conductor.

36. A luggage tag in accordance with claim 35 wherein the first mentioned conductor includes a loop proximate the first end of the strap and the second mentioned conductor includes a loop proximate the second end of the strap to increase the chance of an electrical coupling between the first conductor and the second conductor, whereby possible variations in alignment when the first end is attached to the second end of the strap are accommodated.

37. A luggage tag in accordance with claim 30 wherein the conductor couples the battery to the RFID integrated circuit.

38. A luggage tag in accordance with claim 30 wherein the conductor couples the battery to the RFID integrated circuit and wherein a break in the conductor results in the RFID integrated circuit not being capable of being interrogated.

39. A luggage tag in accordance with claim 26, further comprising a removable no-stick layer over the first surface, at least a portion of the no-stick layer being removable to expose the adhesive.

40. A method of manufacturing a tag device, the method comprising:
providing a strap having a first end and a second end and configured to encircle a member to which the tag device is to be secured;
configuring the first end to be attached to the second end of the strap, with the strap encircling a member to which the tag device is to be secured; and
supporting circuitry from the strap, the circuitry being useful for determining if the strap has been removed from the member after the first end has been attached to the second end.

41. A method in accordance with claim 40 wherein the circuitry includes a first conductor supported by the first end and a second conductor supported by the second end, the method further comprising positioning the first conductor to be electrically coupled to second conductor when the first end is attached to the second end.

42. A method in accordance with claim 41 wherein the circuitry is configured to open-circuit if the strap is removed from the member.

43. A method in accordance with claim 41 wherein the circuitry includes an RFID integrated circuit which can be interrogated when the first conductor is electrically coupled to the second conductor if the strap has not been broken.

44. A method in accordance with claim 43 and further comprising a supporting a battery from the strap and electrically coupling the batter to the RFID integrated circuit.

45. A method in accordance with claim 44 wherein the battery is a thin film battery.

46. A method in accordance with claim 40 and comprising laminating the circuitry onto the strap.

47. A method in accordance with claim 40 wherein supporting circuitry comprises printing conductors on the strap.

48. A method in accordance with claim 40 and comprising defining the strap to have first and second opposite planar surfaces, printing human readable on one of the surfaces, and defining the strap to be a luggage tag, the indicia describing airport routing.

49. A method in accordance with claim 40 and comprising defining the strap to have first and second opposite planar surfaces, printing machine readable indicia printed on one of the surfaces, and defining the strap to be a luggage tag, the indicia describing airport routing.

50. A method in accordance with claim 40 wherein the strap has a length in the direction from the first end to the second end, wherein supporting circuitry comprises providing a conductor pattern substantially extending from the first end to the second end, the conductor pattern being configured to break if the strap is broken.

51. A method in accordance with claim 40 and comprising providing adhesive on the first end and configuring the first end to be attached to the second end using adhesive.

52. A method in accordance with claim 40 and comprising defining a wristband.
